(19) United States
(12) Patent Application Publication
(10) Pub. No.: US 2013/0138335 A1
(43) Pub. Date: May 30, 2013

(54) METHOD AND SYSTEM FOR PROVIDING INFORMATION

(71) Applicant: Hong Lei, Beijing (CN)

(72) Inventor: Hong Lei, Beijing (CN)

(21) Appl. No.: 13/813,061

(22) PCT Filed: Jul. 29, 2011
(86) PCT No.: PCT/CN2011/077819

§ 371 Date: Jan. 29, 2013

(30) Foreign Application Priority Data
Jul. 30, 2010 (CN) 201010240780.9

(51) Int. Cl. G01C 21/00

(52) U.S. Cl. CPC G01C 21/00
USPC 701/408

(57) ABSTRACT

The disclosure provides a method and system for providing information, wherein the method comprises: providing a user with a navigation identifier firstly (S21); obtaining a geographic location of the user (S22); for each of the user, correspondingly storing the navigation identifier and the geographic location of the each of the user (S23); and after receiving the navigation identifier, navigating the user who transmits the navigation identifier according to the geographic location to which the navigation identifier corresponds (S24).

### TECHNICAL FIELD OF THE INVENTION

The disclosure relates to the communication technical field, and in particular to a method and system for providing information.

### BACKGROUND OF THE INVENTION

With the development of economy and society, the urban traffic becomes increasingly complex, and people travel more and more frequently, so various navigation methods come into being as the times require. At present, the common navigation mode is utilizing the Global Positioning System (GPS) to navigate; there is a city map stored in a special navigation terminal, and the special navigation terminal can receive the GPS information; with combination of the information and the map, the navigation information about two certain points on the map can be output; the navigation information is usually presented in a form of map, where a path composed of urban roads between the two points is marked.

Furthermore, with the development of mobile communication technology, the mobile communication terminal, commonly known as the mobile phone, can receive information, such as graphic and text, transmitted from the base station, and the base station can provide, combining with the GPS system, the navigation information for the mobile phone connected to the base station. With support of this function, the user of mobile phone can obtain the navigation information between the current location of the mobile phone and the destination by editing descriptive information of the destination, such as road name or building name, through the mobile phone.

In the traditional art, when the mobile phone or the special navigation terminal is used to navigate, the user needs to input the descriptive information of the destination, such as a certain building or road, overpass and road intersection. In the process of implementing the disclosure, the inventor finds out that if the user cannot provide the geographic descriptive information of the destination, then the navigation information cannot be obtained, for example, person A needs to meet with person B, but the A does not know the current location of the B, i.e. the street or building where the B is, and cannot contact with the B, then the A cannot reach the location of the B. In addition, if the user cannot accurately describe the destination, although some mobile phones or special navigation terminals can give multiple options based on the vague descriptions given by the user, wherein the options are accurate descriptions about the destination, however, under some conditions, the options cannot be given, or the given options are wrong and the user may choose the wrong option to navigate, which causes the wrong navigation.

According to the navigation mode in the traditional art, the user may not be able to obtain the navigation information or may obtain the wrong navigation information. Aiming at the problem, an effective solution has not been provided yet.

### SUMMARY OF THE INVENTION

The disclosure mainly aims to provide a method and system for providing information, so as to solve the problem that the user may not be able to obtain the navigation information or may obtain the wrong navigation information in the traditional art; the disclosure further aims to provide the user with the related information of other surrounding users.

According to one aspect of the disclosure, the following technical solution is provided:

a method for providing information, comprising: obtaining a geographic location of a user; for each of the user, correspondingly storing a navigation identifier and the geographic location of the each of the user; and after receiving the navigation identifier, navigating the user who transmits the navigation identifier according to the geographic location to which the navigation identifier corresponds.

Furthermore, before obtaining the geographic location of the user, the method further comprises: providing the user with the navigation identifier.

Furthermore, providing the user with the navigation identifier comprises: regarding a character string input by the user as the navigation identifier, or regarding a randomly generated character string as the navigation identifier.

Furthermore, obtaining the geographic location of the user comprises: outputting a map, and regarding latitude and longitude coordinates of a location point which is chosen by the user on the map as the geographic location of the user; or obtaining the geographic location of the user comprises: regarding geographic descriptive information input by the user as the geographic location of the user; or obtaining the geographic location of the user comprises: regarding latitude and longitude coordinates input by the user as the geographic location of the user.

Furthermore, navigating the user who transmits the navigation identifier comprises: transmitting path descriptive information to the user who transmits the navigation identifier, wherein the path descriptive information is configured to describe a path from a location specified by the user who transmits the navigation identifier to the geographic location to which the navigation identifier corresponds; the form of the path descriptive information is voice, character, static or dynamic image, or combination of them; or navigating the user who transmits the navigation identifier comprises: providing the user who transmits the navigation identifier with the geographic location to which the navigation identifier corresponds; or navigating the user who transmits the navigation identifier comprises: obtaining path descriptive information between two geographic locations according to the geographic locations to which two received navigation identifiers correspond respectively, and providing the user who transmits the navigation identifier with the path descriptive information; the form of the path descriptive information is voice, character, static or dynamic image, or combination of them.

According to another aspect of the disclosure, the following technical solution is provided:

a method for providing information, comprising: obtaining a geographic location of a user and generating navigation information of the user according to the geographic location of the user, or receiving the navigation information of the user; for each of the user, correspondingly storing a navigation identifier and the navigation information of the each of the user; and after receiving the navigation identifier, providing the user who transmits the navigation identifier with the navigation information to which the navigation identifier corresponds.

Furthermore, before obtaining the geographic location of the user, the method further comprises: providing the user with the navigation identifier.

Furthermore, providing the user with the navigation identifier comprises: regarding a character string input by the user as the navigation identifier, or regarding a randomly generated character string as the navigation identifier.

Furthermore, obtaining the geographic location of the user comprises: outputting a map, and regarding latitude and longitude coordinates of a location point which is chosen by the user on the map as the geographic location of the user; or obtaining the geographic location of the user comprises: regarding the geographic descriptive information input by the user as the geographic location of the user; or obtaining the geographic location of the user comprises: regarding latitude and longitude coordinates input by the user as the geographic location of the user.

Furthermore, generating the navigation information of the user according to the geographic location of the user comprises: generating an orientation diagram of the user according to the geographic location of the user, wherein the orientation diagram of the user is configured to show a position of the geographic location of the user in the map; the navigation information includes the orientation diagram; or generating the navigation information of the user according to the geographic location of user comprises: generating information of riding route or information of driving route to reach the geographic location according to the geographic location of the user; wherein the navigation information includes the information of riding route or the information of driving route.

According to another aspect of the disclosure, the following technical solution is provided:

a method for providing information, comprising: obtaining a geographic location of a user; for each of the user, correspondingly storing a navigation identifier and the geographic location of the each of the user; and after receiving a surrounding query request, determining the user whose geographic location belongs to a geographic scope specified by the surrounding query request according to the geographic scope and the geographic location of the user who sends the surrounding query request, and then providing the user who sends the surrounding query request with the navigation identifier of the user determined.

Furthermore, before obtaining the geographic location of the user, the method further comprises: providing the user with the navigation identifier.

Furthermore, providing the user with the navigation identifier comprises: regarding a character string input by the user as the navigation identifier, or regarding a randomly generated character string as the navigation identifier.

Furthermore, obtaining the geographic location of the user comprises: outputting a map, and regarding latitude and longitude coordinates of a location point which is chosen by the user on the map as the geographic location of the user; or obtaining the geographic location of the user comprises: regarding geographic descriptive information input by the user as the geographic location of the user; or obtaining the geographic location of the user comprises: regarding latitude and longitude coordinates input by the user as the geographic location of the user.

Furthermore, before receiving the surrounding query request, further comprising: receiving user information transmitted by the user, and then storing the user information corresponding to the navigation identifier of the user; after determining the user whose geographic location belongs to the geographic scope, further comprising: providing the user who sends the surrounding query request with the user information of the user determined.

Furthermore, after providing the user who sends the surrounding query request with the navigation identifier of the user determined, the method further comprises: receiving the navigation identifier, and then providing the user who transmits the navigation identifier with the geographic location to which the navigation identifier corresponds.

According to another aspect of the disclosure, the following technical solution is provided:

a system for providing information, comprising: a geographic location obtaining module, configured to obtain a geographic location of a user; a storing module, configured to, for each of the user, correspondingly store a navigation identifier and the geographic location of the each of the user; a receiving module, configured to receive the navigation identifier; and a navigating module, configured to navigate the user who transmits the navigation identifier according to a stored map and the geographic location to which the navigation identifier received by the receiving module corresponds.

Furthermore, the system comprises a navigation identifier providing module, configured to provide the user with the navigation identifier.

According to another aspect of the disclosure, the following technical solution is provided:

a system for providing information, comprising: a geographic location obtaining module, configured to obtain a geographic location of a user; a navigation information generating module, configured to generate navigation information of the user according to the geographic location of the user; a storing module, configured to, for each of the user, correspondingly store a navigation identifier and the navigation information of the each of the user; a receiving module, configured to receive the navigation identifier; and a navigating module, configured to provide the user who transmits the navigation identifier with the navigation information to which the navigation identifier received by the receiving module corresponds.

Furthermore, the system further comprises a navigation identifier providing module, configured to provide the user with the navigation identifier.

According to another aspect of the disclosure, the following technical solution is provided:

a system for providing information, comprising: a geographic location obtaining module, configured to obtain a geographic location of a user; a storing module, configured to, for each of the user, correspondingly store a navigation identifier and the geographic location of the each of the user; a query receiving module, configured to receive a surrounding query request; a determining module, configured to determine the user whose geographic location belongs to a geographic scope specified by the surrounding query request according to the geographic scope and the geographic location of the user who sends the surrounding query request; and an outputting module, configured to provide the user who sends the surrounding query request with the navigation identifier of the user determined by the determining module.

Furthermore, the system further comprises a navigation identifier providing module, configured to provide the user with the navigation identifier.

Furthermore, the system further comprises a user information receiving module, configured to receive the user information transmitted by the user; the storing module is further configured to store the user information; the outputting module is further configured to provide the user who sends the surrounding query request with the user information of the user determined by the determining module.

Furthermore, the query receiving module is further configured to receive the navigation identifier; the determining module is further configured to determine the geographic location to which the navigation identifier received by the query receiving module corresponds; the outputting module is further configured to provide the user who transmits the navigation identifier with the geographic location determined by the determining module.

According to the technical solution of the disclosure, a geographic location database of the user is established by obtaining the geographic location of the user, and correspondingly storing the navigation identifier and the geographic location for each user; then, after receiving the navigation identifier, the geographic location of user can be determined according to the database, and further the navigation service is provided for the user. In this way, when the use goes to the target user to be found, the user can obtain the navigation service by only remembering the navigation identifier of the target user, thereby ensuring that the user obtains the right navigation information. The other beneficial effects of the disclosure can be obtained from descriptions in the specific embodiments.

### BRIEF DESCRIPTION OF THE DRAWINGS

The accompanying drawings described here are used for providing a further understanding of the disclosure, and constitute a part of the application; the schematic embodiment and specification of the disclosure are used for illustrating it and not intended to form improper limit to the disclosure. In the accompanying drawings:

FIG. 1 shows a diagram of an application scene according to the embodiment of the disclosure;

FIG. 2 shows a diagram of the main flow of a method for providing information according to the embodiment of the disclosure;

FIG. 3 shows a diagram of the main flow of another method for providing information according to the embodiment of the disclosure;

FIG. 4 shows a diagram of the main flow of another method for providing information according to the embodiment of the disclosure;

FIG. 5 shows a structural diagram of a system for providing information according to the embodiment of the disclosure;

FIG. 6 shows a structural diagram of another system for providing information according to the embodiment of the disclosure;

FIG. 7 shows a structural diagram of another system for providing information according to the embodiment of the disclosure; and

FIG. 8 shows a diagram of distributing users into the map according to the embodiment of the disclosure.

### DETAILED DESCRIPTION OF THE EMBODIMENTS

The disclosure is described below with reference to the accompanying drawings and embodiments in detail. Under the condition of not causing conflict, these technical solutions in the embodiment can be combined with each other.

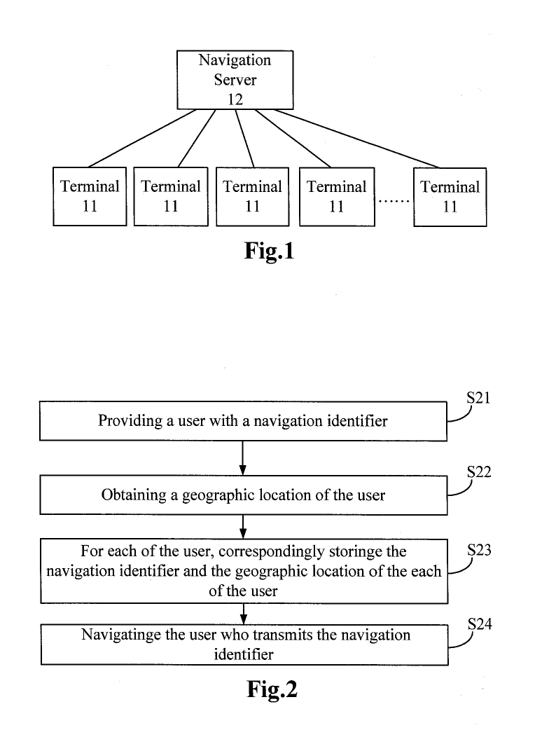

FIG. 1 shows a diagram of an application scene according to the embodiment of the disclosure. The technical solutions in the embodiment of the disclosure enable the terminal equipment to obtain the navigation information from the navigation system. The terminal equipment and the navigation system are shown in FIG. 1, and the navigation system can serve multiple terminals. In FIG. 1, the multiple terminals 11 can connect with the navigation server 12 through the existing wireless communication systems, such as the Global System for Mobile Communication (GSM) and the Code Division Multiple Access (CDMA), or through various wireless communication systems in the future, or through the Internet or other computer networks. The navigation server 12 is further equipped with a storing device and a computing device besides of the device for communication. The storing device can store the map data and other data. The computing device has a computing function, including the computation performed according to the map data, the other data and the information transmitted from the terminal. The terminal equipment can be the above-mentioned communication system or the computer system, and is usually operated by the user. Thus, in the descriptions in the embodiment of the disclosure, the terminal 11 transmits information to the navigation server 12, which is described as that the user transmits information to the navigation server, that is, the user uses the terminal equipment to transmit information to the navigation server.

FIG. 2 shows a diagram of the main flow of a method for providing information according to the embodiment of the disclosure.

As shown in FIG. 2, the information provided in the method is specifically information about navigation, that is, the user can be navigated by the method. The method for navigation can be completed by the navigation server 12 in FIG. 1; using the method enables a user to provide the navigation server 12 with the navigation identifier of a target user by operating the terminal equipment, thereby obtaining the navigation information and then enabling the user to move according to the navigation information to find the target user. The navigation server in the embodiment can be single computer or multiple computers. The method shown in FIG. 2 mainly comprises the following steps:

Step S21: providing a user(s) with the navigation identifier;

Step S22: obtaining a geographic location of the user(s);

Step S23: for each of the user(s), correspondingly storing the navigation identifier and the geographic location of the each of the user(s); and

Step S24: after receiving the navigation identifier, navigating the user(s) who transmits the navigation identifier according to the geographic location to which the navigation identifier corresponds.

The steps S21-S24 above are further described below.

In Step S21, specifically, the descriptive information in form of character string can be provided for the user, for prompting the user to input character string according to the descriptive information, and then the character string input by the user is regarded as the navigation identifier. For example, the user is prompted to input six digitals as the navigation identifier; the user can also be prompted to regard other character strings as the navigation identifier. The form of the character string can be diversified and the character string can include characters of countries around the world. The character string can also be randomly generated by the navigation server to serve as the navigation identifier. In the initialization phase, the user can be provided with a register interface, and is further provided with the navigation identifier after registering the username. The user can log on later with the username as well as the navigation identifier, and directly turning to Step S22.

In Step S22, the geographic location of the user can be obtained by various methods. For example, a map can be output, and the latitude and longitude coordinates of a location point, which is chosen by the user, on the map is regarded as the geographic location of the user. Specifically, a map is output to the user; the user can click, through a mouse, on the map which is displayed on a man-machine interface, and then according to the clicked location point, the latitude and longitude coordinates of the location point on the map can be obtained and displayed in the form of floating window, at the same time, the latitude and longitude coordinates are displayed in the text input box on the man-machine interface; the user can modify the latitude and longitude coordinates in the text input box and then clicks the ‘OK’ button, or directly clicks the ‘OK’ button without modification to submit the latitude and longitude coordinates. Alternatively, the user also can not choose the location point on the map, but directly input the latitude and longitude coordinates on the text input box. In addition, the user can input the geographic descriptive information, and then the navigation server regards the geographic descriptive information as the geographic location of the user. The form of the geographic descriptive information can be diversified. For example, in the city, the geographic descriptive information can be described with reference to a certain landmark building, or can be a certain road, a certain overpass and so on. The logged-on user can modify the geographic location, and then the navigation server obtains and stores the new geographic location of the user. With the increase of the number of users, the load on the navigation server is increased, so another navigation server can be used exclusively for obtaining the geographic location of the user and performing storing in Step S23.

The steps S21-S23 can be regard as a process of establishing the database; after completing this three steps one by one for multiple users, any user can reach the geographic locations of these users by getting the navigation service through the navigation server. The process of establishing the database can be continuous, thus, a broader scope of navigation services can be provided.

The navigation server may receive the navigation identifier at any time, which means there is user needing navigation to reach the geographic location of the user to which the navigation identifier belongs. The received navigation identifier can be included in a navigation request; other items that should be known by the navigation server can be attached in the navigation request and added according to the need in an implementing process. After receiving the navigation identifier, Step S24 is triggered.

In Step S24, the navigation server transmits the navigation information in the next navigation service according to the identifier of the terminal used by the user, since the navigation identifier transmitted by the user is received, wherein it is usually said that what is received is the request information including the navigation identifier, and the request information is used for requesting to obtain the navigation service, and usually also includes the identifier of the terminal used by the user, such as the username, or the mobile phone number which is adopted by the user to transmit the navigation identifier through a wireless communication network. In Step S24, the user can be navigated in manner of directing the way. Directing the way means showing the user a path from the current location to the target location at one time, for example, the information of directing the way can be ‘going straight for 500 meters along Shengli Road and turning right to Wusi Road, and then going straight for 300 meters to reach Red Star Hotel’. Thus, in Step S24, if the navigation is performed in manner of directing the way, the current location of the user is obtained, and then the path descriptive information is transmitted to the user, wherein the path descriptive information is used for describing the path from the current location of the user to the target geographic location. The target geographic location is the geographic location to which the navigation identifier received in Step S24 corresponds; because the navigation identifier and the geographic location of the user are correspondingly stored in Step S23, the geographic location of the user can be determined according to the navigation identifier of the user. The current location of the user either can be obtained according to the attached information in the above-mentioned navigation request or can be obtained by, after receiving the navigation identifier transmitted by the user, requiring the user to transmit the current location, for example, the geographic descriptive information such as a certain road or a certain building, or certain latitude and longitude coordinates. It can be seen from the above that this mode does not require the terminal equipment used by the navigated user to have the GPS function. If the user uses the terminal with the GPS function, then in Step S24, the target geographic location is directly transmitted to the user, wherein the target geographic location can be either the geographic descriptive information or the latitude and longitude coordinates.

The user can transmit two navigation identifiers to the network server through the terminal equipment to require for obtaining the path description between geographic locations to which the two navigation identifiers correspond respectively. Correspondingly, the navigation server obtains two geographic locations to which the two navigation identifiers correspond according to the two navigation identifiers, and then obtains the path descriptive information between the two geographic locations.

It can be seen from the flow shown in FIG. 2 that the database can be established in the way of providing the user with the navigation identifier and storing the geographic location of the user, and the user is provided with the navigation service based on the database. This way enables the user to obtain the navigation service by only remembering the navigation identifier of the target user when going to the target user to be found. In the embodiment, the navigation identifier can be freely specified by the user, thus, the user can adopt the form of navigation identifier which is easily remembered, or adopt own mobile phone number as the own navigation identifier, which enables the other user to obtain the navigation information conveniently according the navigation identifier.

When the user is navigated in Step S24, the form of the path descriptive information can be voice, character, static or dynamic image, or combination of them; the transmitting mode can adopt various wired or wireless communication networks and computer networks which are existing or to be expected in future. In the implementing process, the navigation server can be connected with some information medium. For example, the user transmits the request information including the navigation identifier in the way of the short message of the mobile phone, wherein the short message is usually sent to the network equipment of the short message service provider, and then is sent to the navigation server by the network equipment; the network equipment plays a role of information medium. Thus, the navigation identifier received by the navigation server not only can be from the user directly, but also can be from the information medium. The user can also call the information service center (call center) to tell the staff the navigation identifier, now the user transmits the navigation identifier in the form of voice; the staff of the information service center transmits the navigation identifier to the navigation server by operating related equipment. Thereby, the equipment and staff of the information service center play a role of information medium. To sum up, the embodiment can have various flexible application ways in the implementing process.

In the implementing process, when obtaining the path descriptive information according to the geographic location, the navigation server can use other special equipment for computing path, and transmits the geographic location, such as the latitude and longitude coordinates to the equipment, so that the equipment computes and then feeds back the path to the navigation server. Of course, the navigation server can also compute the path according to the map stored by itself. In a word, various ways in the traditional art can be adopted to compute the path.

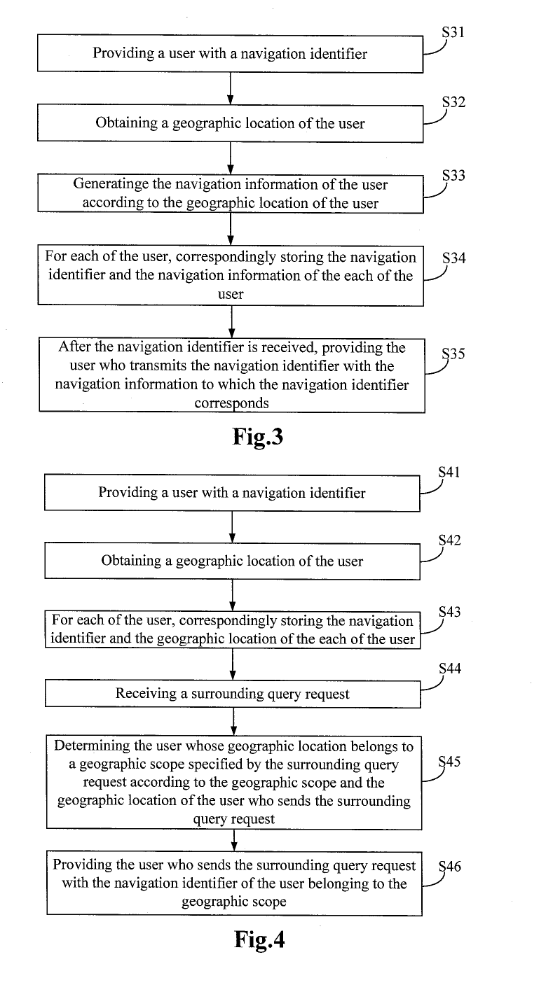

Another method for providing information in the embodiment of the disclosure is described below. FIG. 3 shows a diagram of the main flow of another method for providing information according to the embodiment of the disclosure. The navigation for user can be implemented according to the flow shown in FIG. 3. The flow shown in FIG. 3 comprises the following steps:

Step S31: providing a user(s) with the navigation identifier;

Step S32: obtaining the geographic location of the user(s);

The two steps are similar to above-mentioned Step S21 and Step S22;

Step S33: generating the navigation information of the user(s) according to the geographic location of the user(s);

Step S34: for each of the user(s), correspondingly storing the navigation identifier and the navigation information of the each of the user(s); and

Step S35: after receiving the navigation identifier, provide the user(s) who transmits the navigation identifier with the navigation information to which the navigation identifier corresponds.

The steps S33 to S35 are further described below.

In Step S33, specifically, the orientation diagram of the user is generated according to the geographic location of the user, wherein the orientation diagram of the user is used for showing the position of the geographic location of the user in the map. Being similar to the above-mentioned mode, the user chooses the location point on the map. When the orientation diagram of the user is generated, one part of the map can be intercepted according to the location point chosen by the user, wherein the part includes the location point, and then the part of the map is regarded as the orientation diagram of the user. If the geographic location is the latitude and longitude coordinates directly input by the user, then the orientation diagram is obtained according to the latitude and longitude coordinates. In this way, the navigation information is specifically the orientation diagram.

In Step S33, the information of riding route or the information of driving route to reach the geographic location can be generated according to the geographic location of the user. The riding route is similar to the riding route provided in various current advertisements, and mainly means the manner of taking public transportation; the information of driving route is similar to the above-mentioned information of directing the way, but the information of driving route mainly describes the driving routes near the target geographic location, for example, if the target geographic location is the Red Star Hotel, then the information of driving route is ‘entering from west entry of Wusi Road and going ahead for 500 meters’ or other detailed description ways. In this way, the navigation information is specifically the above-mentioned information of riding route or information of driving route.

In the implementing process, the steps S31-S33 can be skipped, and the navigation information of the user is directly received; the navigation information can be the above-mentioned information of riding route or information of driving route, and is edited by the user freely and then transmitted to the navigation server; the navigation server stores the received navigation information as the navigation information of the user, corresponding to the navigation identifier of the user.

It can be seen that, according to the flow shown in FIG. 3, the terminal equipment used by the user can obtain the navigation information when the terminal equipment does not have the GPS function.

The method for providing information in the embodiment of the disclosure can be not only used for navigating and but also used for providing other information. An example is shown below. FIG. 4 shows a diagram of the main flow of another method for providing information according to the embodiment of the disclosure. As shown in FIG. 4, the method mainly comprises the following steps:

Step S41: providing a user(s) with the navigation identifier;

Step S42: obtaining the geographic location of the user(s);

Step S43: for each of the user(s), correspondingly storing the navigation identifier and the geographic location of the each of the user(s);

This three steps are similar to above-mentioned steps S21-S23;

Step S44: receiving the surrounding query request, wherein the surrounding query request is the request information transmitted to the navigation server by the user(s) when the user(s) needs to know information of other users around the geographic location of the user(s); the surrounding query request includes the navigation identifier of the user who transmits the request, and the navigation server can determine the geographic location of the user according to the navigation identifier; the user also needs to specify the geographic scope in the surrounding query request, for example, the description of geographic scope, such as a circular area with radius of 1 kilometre;

Step S45: determining the user whose geographic location belongs to the geographic scope specified by the surrounding query request according to the geographic scope and the geographic location of the user who sends the surrounding query request; the user who belongs to the geographic scope can be determined according to the combination of the stored map and the stored geographic location of the user. It is not difficult to be seen that this way usually can determine multiple users, and these users are geographically within the scope specified by the user who sends the surrounding query request; and

Step S46: providing the user who sends the surrounding query request with the navigation identifier of the user belonging to the geographic scope; in this way, after obtaining the navigation identifiers of other users in the scope needed by the user who sends the surrounding query request, the user who sends the surrounding query request can obtain further information in combination with the navigation identifier. The further information is described below.

In the navigation server, the information, such as the navigation identifier and geographic location of the user can be stored; in addition, a user information database can be established for the user, wherein the user information database appears as a personal homepage at the user side. The user can add various information related to the user itself in the personal homepage, and the information can mainly be personal information, such as personal resumes and hobbies; regarding the case that the user is an organization (unit or company), the introduction of the organization can be added. All the information is stored in the user information database and is called user information in the description below. Thus, before Step S44, the navigation server can receive the user information transmitted by the user and stores the user information corresponding to the navigation identifier of the user. In addition, the navigation server can also provide a function of enabling the users to communicate with each other.

In this way, after Step S45, the navigation server can transmit the user information of the user who belongs to the geographic scope to the user who sends the surrounding query request. In addition, after Step S46, if the user who sends the surrounding query request needs to know the further information of the user who belongs to the geographic scope, the navigation identifier of the user who belongs to the geographic scope can be transmitted to the navigation server, and then the navigation server provides the user who sends the surrounding query request with the user information of the user to which the navigation identifier corresponds, according to the received navigation identifier; in addition, the navigation server can also provide the user who sends the surrounding query request with the geographic location to which the navigation identifier corresponds.

It can be seen from the flow shown in FIG. 4 that the user can obtain the navigation identifier or the user information, the geographic location of the users nearby through the navigation server, because the navigation server stores the geographic location and user information of each user. In this way, the user can do related activities based on the obtained information, for example, if a certain user is a restaurant, then the user can send advertisements to the users nearby through the Internet.

The system for providing information in the embodiment of the disclosure is described below.

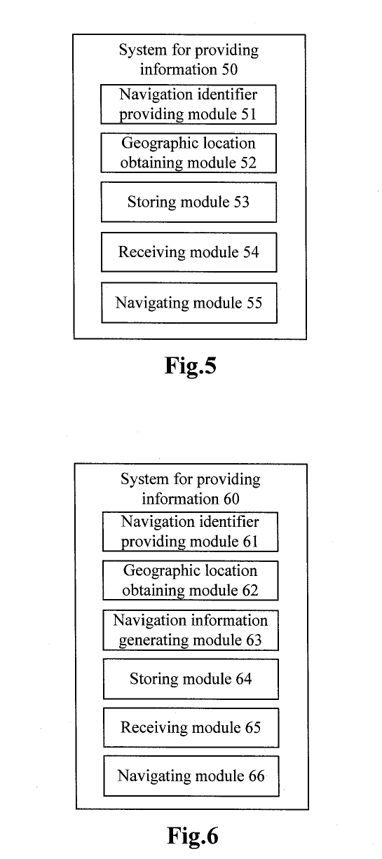

FIG. 5 shows a structural diagram of a system for providing information according to the embodiment of the disclosure. As shown in FIG. 5, the system 50 for providing information mainly includes the following modules:

a navigation identifier providing module 51, which is configured to provide a user(s) with a navigation identifier;

a geographic location obtaining module 52, which is configured to obtain a geographic location of the user(s);

a storing module 53, which is configured to, for each of the user(s), correspondingly store the navigation identifier and the geographic location of the each of the user(s);

a receiving module 54, which is configured to receive the navigation identifier; and

a navigating module 55, which is configured to navigate the user(s) who transmits the navigation identifier according to the geographic location to which the navigation identifier received by the receiving module 54 corresponds and the stored map.

If the system for providing information is set up based on the user(s) who has the navigation identifiers, then the system for providing information may not include the navigation identifier providing module 51.

FIG. 6 shows a structural diagram of another system for providing information according to the embodiment of the disclosure. As shown in FIG. 6, the system 60 for providing information mainly includes the following modules:

a navigation identifier providing module 61, which is configured to provide a user(s) with a navigation identifier;

a geographic location obtaining module 62, which is configured to obtain a geographic location of the user(s);

a navigation information generating module 63, which is configured to generate navigation information of the user(s) according to the geographic location of the user(s);

a storing module 64, which is configured to, for each of the user(s), correspondingly store the navigation identifier and the navigation information of the each of the user(s);

a receiving module 65, which is configured to receive the navigation identifier; and

a navigating module 66, which is configured to provide the user(s) who transmits the navigation identifier with the navigation information to which the navigation identifier received by the receiving module 65 corresponds.

If the system for providing information is set up based on the user(s) who has the navigation identifiers, then the system for providing information may not include the navigation identifier providing module 61.

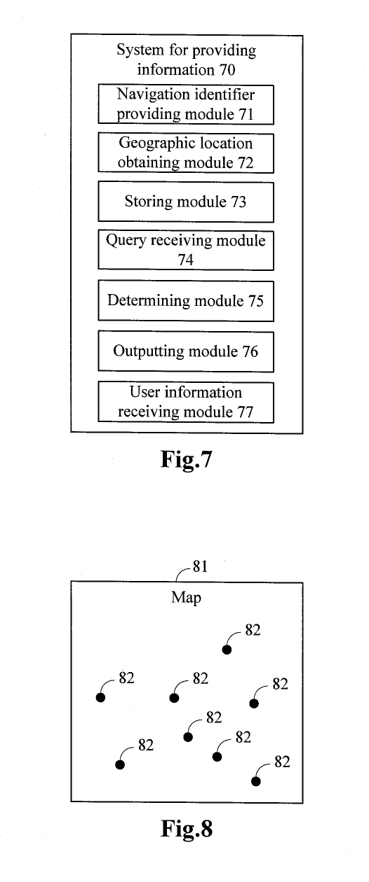

FIG. 7 shows a structural diagram of another system for providing information according to the embodiment of the disclosure. As shown in FIG. 7, the system 70 for providing information mainly includes the following modules:

a navigation identifier providing module 71, which is configured to provide a user(s) with a navigation identifier;

a geographic location obtaining module 72, which is configured to obtain a geographic location of the user(s);

a storing module 73, which is configured to, for each of the user(s), correspondingly store the navigation identifier and the geographic location of the each of the user(s);

a query receiving module 74, which is configured to receive a surrounding query request;

a determining module 75, which is configured to determine the user(s) whose geographic location belongs to the geographic scope specified by the surrounding query request according to the geographic scope and the geographic location of the user(s) who sends the surrounding query request; and

an outputting module 76, which is configured to provide the user(s) who sends the surrounding query request with the navigation identifier of the user(s) determined by the determining module 75.

If the system for providing information is set up based on the user(s) who has the navigation identifiers, then the system for providing information may not include the navigation identifier providing module 71.

The system 70 for providing information shown in FIG. 7 can also include a user information receiving module 77, which is configured to receive user information transmitted by the user(s); further, the storing module can also be configured to store the user information, the outputting module 76 can also be configured to provide the user who sends the surrounding query request with the user information of the user determined by the determining module 75.

In the system 70 for providing information shown in FIG. 7, the query receiving module 74 can also be configured to receive the navigation identifier; the determining module 75 can also be configured to determine the geographic location to which the navigation identifier received by the query receiving module corresponds; the outputting module 76 can also be configured to provide the user who transmits the navigation identifier with the geographic location determined by the determining module.

It can be seen from the embodiment of the disclosure above that the distribution of users to the map is realized by correspondingly storing the navigation identifier and the geographic location, and the following operations can be performed based on the map with users; this way can be seen from FIG. 8. FIG. 8 shows a diagram of distributing users into the map according to the embodiment of the disclosure; in the diagram, each dot 82 in the map 81 represents a user. In people's daily action, there are many affairs which directly relate to the geographic location, such as looking for someone, looking for an organization, and publishing information, and thus in the embodiments of the disclosure, a kind of method for providing information is provided in the embodiments of the disclosure based on the way that the user and the geographic location correspond to each other; the method can be used for navigating and providing various information. In the method, the database can be established depending on the information input by the user, which is comparatively simple to realize. The application of the technical solution in the embodiment of the disclosure can bring about multiple practical beneficial effects. For example, adopting the navigating method provided by the embodiment, the user can conveniently obtain the navigation service just by carrying a mobile phone, thereby saving time, and saving fuel consumption of vehicle in many cases because of avoiding unnecessary long way. When the number of the users is huge, quite large quantity of fuel will be saved. In another example, adopting the method provided by the embodiment, the user can obtain the information of other users nearby; in many cases, the communications among people are based on the approach of the space, so the method according to the embodiment enables people to communicate with each other conveniently.

It can be seen from the technical solution in the embodiment of the disclosure that the scope of services of navigating or providing information is constantly expanded in the case that the number of users served by the navigation server is increased, so it can be reasonably predicted that if most individuals and organizations in an area register on the navigation server in the embodiment and adopt the navigation identifier to do activities, then the considerable social benefits can be produced, for example, saving large quantity of fuel and time, and facilitating communications among people.

Obviously, the skilled personnel in the field should understand that the above-mentioned modules or steps of the disclosure can be realized by a common computing device, and they can be integrated on a single computing device, or distributed on the network composed of multiple computing devices; optionally, they can be realized by the program code which is capable of being executed by the computing device; thereby, they can be stored in a storing device and executed by the computing device; or they are realized by making them into each integrated circuit module, respectively, or by making multiple modules or steps of them into a single integrated circuit module. Thus, the disclosure is not limited to any specific combination of hardware and software.

The above is only a preferred embodiment of the disclosure, and not used for limiting the disclosure; for the skilled personnel in the field, the disclosure may have various modifications and variations. Without departing from the scope and spirit of the disclosure, any made modification, equivalent replacement and improvement are within the scope of the claims of the disclosure.

What is claimed is:

1. A method for providing information, comprising:
obtaining a geographic location of a user;
for each of the user, correspondingly storing a navigation identifier and the geographic location of the each of the user; and
after receiving the navigation identifier, navigating the user who transmits the navigation identifier according to the geographic location to which the navigation identifier corresponds.

2. The method according to claim 1, before obtaining the geographic location of the user, further comprising: providing the user with the navigation identifier.

3. The method according to claim 2, wherein providing the user with the navigation identifier comprises: regarding a character string input by the user as the navigation identifier, or regarding a randomly generated character string as the navigation identifier.

4. The method according to claim 1, wherein
obtaining the geographic location of the user comprises: outputting a map, and regarding latitude and longitude coordinates of a location point which is chosen by the user on the map as the geographic location of the user; or
obtaining the geographic location of the user comprises: regarding geographic descriptive information input by the user as the geographic location of the user; or
obtaining the geographic location of the user comprises: regarding latitude and longitude coordinates input by the user as the geographic location of the user.

5. The method according to any one of claims 1 to 4, wherein
navigating the user who transmits the navigation identifier comprises: transmitting path descriptive information to the user who transmits the navigation identifier, wherein the path descriptive information is configured to describe a path from a location specified by the user who transmits the navigation identifier to the geographic location to which the navigation identifier corresponds; the form of the path descriptive information is voice, character, static or dynamic image, or combination of them; or
navigating the user who transmits the navigation identifier comprises: providing the user who transmits the navigation identifier with the geographic location to which the navigation identifier corresponds; or
navigating the user who transmits the navigation identifier comprises: obtaining path descriptive information between two geographic locations according to the geographic locations to which two received navigation identifiers correspond respectively, and providing the user who transmits the navigation identifier with the path descriptive information; the form of the path descriptive information is voice, character, static or dynamic image, or combination of them.

6. A method for providing information, comprising:
obtaining a geographic location of a user and generating navigation information of the user according to the geographic location of the user, or receiving the navigation information of the user;
for each of the user, correspondingly storing a navigation identifier and the navigation information of the each of the user; and
after receiving the navigation identifier, providing the user who transmits the navigation identifier with the navigation information to which the navigation identifier corresponds.

7. The method according to claim 6, before obtaining the geographic location of the user, further comprising: providing the user with the navigation identifier.

8. The method according to claim 7, wherein providing the user with the navigation identifier comprises: regarding a character string input by the user as the navigation identifier, or regarding a randomly generated character string as the navigation identifier.

9. The method according to claim 6, wherein
obtaining the geographic location of the user comprises: outputting a map, and regarding latitude and longitude coordinates of a location point which is chosen by the user on the map as the geographic location of the user; or
obtaining the geographic location of the user comprises: regarding the geographic descriptive information input by the user as the geographic location of the user; or
obtaining the geographic location of the user comprises: regarding latitude and longitude coordinates input by the user as the geographic location of the user.

10. The method according to any one of claims 6 to 9, wherein
generating the navigation information of the user according to the geographic location of the user comprises: generating an orientation diagram of the user according to the geographic location of the user, wherein the orientation diagram of the user is configured to show a position of the geographic location of the user in the map; the navigation information includes the orientation diagram; or
generating the navigation information of the user according to the geographic location of user comprises: generating information of riding route or information of driving route to reach the geographic location according to the geographic location of the user; wherein the navigation information includes the information of riding route or the information of driving route.

11. A method for providing information, comprising:
obtaining a geographic location of a user;
for each of the user, correspondingly storing a navigation identifier and the geographic location of the each of the user; and
after receiving a surrounding query request, determining the user whose geographic location belongs to a geographic scope specified by the surrounding query request according to the geographic scope and the geographic location of the user who sends the surrounding query request, and then providing the user who sends the surrounding query request with the navigation identifier of the user determined.

12. The method according to claim 11, before obtaining the geographic location of the user, further comprising: providing the user with the navigation identifier.

13. The method according to claim 12, wherein providing the user with the navigation identifier comprises: regarding a character string input by the user as the navigation identifier, or regarding a randomly generated character string as the navigation identifier.

14. The method according to claim 11, wherein
obtaining the geographic location of the user comprises: outputting a map, and regarding latitude and longitude coordinates of a location point which is chosen by the user on the map as the geographic location of the user; or
obtaining the geographic location of the user comprises: regarding geographic descriptive information input by the user as the geographic location of the user; or
obtaining the geographic location of the user comprises: regarding latitude and longitude coordinates input by the user as the geographic location of the user.

15. The method according to any one of claims 11 to 14, wherein
before receiving the surrounding query request, further comprising: receiving user information transmitted by the user, and then storing the user information corresponding to the navigation identifier of the user;
after determining the user whose geographic location belongs to the geographic scope, further comprising: providing the user who sends the surrounding query request with the user information of the user determined.

16. The method according to any one of claims 11 to 14, wherein after providing the user who sends the surrounding query request with the navigation identifier of the user determined, further comprising:
receiving the navigation identifier, and then providing the user who transmits the navigation identifier with the geographic location to which the navigation identifier corresponds.

17. A system for providing information, comprising:
a geographic location obtaining module, configured to obtain a geographic location of a user;
a storing module, configured to, for each of the user, correspondingly store a navigation identifier and the geographic location of the each of the user;
a receiving module, configured to receive the navigation identifier; and
a navigating module, configured to navigate the user who transmits the navigation identifier according to a stored map and the geographic location to which the navigation identifier received by the receiving module corresponds.

18. The system according to claim 17, further comprising a navigation identifier providing module, configured to provide the user with the navigation identifier.

19. A system for providing information, comprising:
a geographic location obtaining module, configured to obtain a geographic location of a user;
a navigation information generating module, configured to generate navigation information of the user according to the geographic location of the user;
a storing module, configured to, for each of the user, correspondingly store a navigation identifier and the navigation information of the each of the user;
a receiving module, configured to receive the navigation identifier; and
a navigating module, configured to provide the user who transmits the navigation identifier with the navigation information to which the navigation identifier received by the receiving module corresponds.

20. The system according to claim 19, further comprising a navigation identifier providing module, configured to provide the user with the navigation identifier.

21. A system for providing information, including:
a geographic location obtaining module, configured to obtain a geographic location of a user;
a storing module, configured to, for each of the user, correspondingly store a navigation identifier and the geographic location of the each of the user;
a query receiving module, configured to receive a surrounding query request;
a determining module, configured to determine the user whose geographic location belongs to a geographic scope specified by the surrounding query request according to the geographic scope and the geographic location of the user who sends the surrounding query request; and
an outputting module, configured to provide the user who sends the surrounding query request with the navigation identifier of the user determined by the determining module.

22. The system according to claim 21, further comprising a navigation identifier providing module, configured to provide the user with the navigation identifier.

23. The system according to claim 21, wherein
the system further comprises a user information receiving module, configured to receive the user information transmitted by the user;
the storing module is further configured to store the user information;
the outputting module is further configured to provide the user who sends the surrounding query request with the user information of the user determined by the determining module.

24. The system according to claim 21, 22 or 23, wherein
the query receiving module is further configured to receive the navigation identifier;
the determining module is further configured to determine the geographic location to which the navigation identifier received by the query receiving module corresponds;
the outputting module is further configured to provide the user who transmits the navigation identifier with the geographic location determined by the determining module.
